(19) United States
(12) Patent Application Publication
(10) Pub. No.: US 2018/0309594 A1
(43) Pub. Date: Oct. 25, 2018

(54) Systems and Methods for Creating an Integrated Layer 2-Layer 3 Hybrid VPN Network

(71) Applicant: AT&T Intellectual Property I, L.P., Atlanta, GA (US)

(72) Inventors: James Uttaro, Staten Island, NY (US); Avinash Lingala, Edison, NJ (US)

(21) Appl. No.: 15/492,120

(22) Filed: Apr. 20, 2017

(51) Int. Cl. H04L 12/46; H04L 29/08

(52) U.S. Cl. CPC H04L 12/4641; H04L 69/321

(57) ABSTRACT

In an integrated Layer 2-layer 3 hybrid VPN network a Layer 3 provider edge device that runs in an EVPN domain and a Layer 3 VPN domain defines an interconnect point between the EVPN domain and the Layer 3 VPN domain. The Layer 3 provider edge device receives an IP prefix for a Layer 3 customer edge device disposed in the Layer 3 VPN domain. The Layer 3 provider edge device receives a MAC address, an IP address and a next hop address for an EVPN customer edge device disposed in the EVPN domain from an EVPN provider edge device disposed in the EVPN domain. The Layer 3 provider edge device leaks the IP prefix to the EVPN domain and transmits state information to the EVPN customer edge device.

### TECHNICAL FIELD

This invention relates to digital computer network technology. More specifically it relates to methods, systems and computer readable media for creating an integrated Layer 2-Layer 3 hybrid VPN network.

### BACKGROUND

A Virtual Private Network (VPN) provides secure network connections between different sites. There are three types of VPN. VPNs are classified by the network Layer used to establish the connection between the customer and provider network. A Layer 1 VPN is a VPN whose data plane operates at layer 1. Layer 1 VPNs are point-to-point connections such as leased lines, ISDN links, and dial-up connections. In a Layer 2 VPN the provider delivers Layer 2 circuits to the customer and provides switching of the customer data. In a Layer 2 VPN the customer routes are transparent to the provider. Layer 2 VPNs are typically based on Frame Relay or ATM packet technologies. In a Layer 3 VPN the provider router participates in the customer's Layer 3 routing. That is, the customer edge routers (CE routers) advertise their routes to the provider. The PE manages the VPN-specific routing tables, as well as distributing routes to remote sites. In a Layer 3 IP VPN, customer sites are connected via IP routers (PEs and P nodes) that can communicate privately over a shared backbone. Multi-protocol label switching (MPLS) or Border Gateway Protocol (BGP) may be utilized in a Layer 3 VPN.

A typical Ethernet network operates in Layer 2. In an Ethernet network the access node creates a MAC header that may be used to switch the frame across the Ethernet network. Other networks, such as Internet Protocol (IP) networks will operate in Layer 3. IP networks forward packets based on an IP address of an IP header associated with an IP packet. In a conventional IP network, an IP lookup is performed at each hop through the network. That is, each node will strip off the outer Ethernet header, read the IP header, and do an IP lookup to route the packet through the network. The node will then add a new Ethernet header to forward the packet to the next node on the network.

The big difference between Layer 2 vs Layer 3 has to do with addressing. Layer 2 networks use a MAC address to send data around a local area on a Switch. The MAC address is a local, permanent and unique name for the device. Layer 3 networks use internet protocol (IP) address to send information between larger networks using Routers. Layer 3 networks are built to run on Layer 2 networks.

An Ethernet VPN (EVPN) enables network providers to connect dispersed customer sites using a Layer 2 virtual bridge. As with other types of VPNs, an EVPN consists of customer edge (CE) devices (host, router, or switch) connected to provider edge (PE) routers. The PE routers can include an MPLS edge switch (MES) that acts at the edge of the MPLS infrastructure. The policy attributes of an EVPN are similar to an IP VPN (for example, Layer 3 VPNs). Each EVPN routing instance requires that the configuration of a route distinguisher (RD) and one or more route targets (RTs).

An EVPN instance comprises Customer Edge devices (CEs) that are connected to Provider Edge devices (PEs) that form the edge of the MPLS infrastructure. A CE may be a host, a router, or a switch. The PEs provide virtual Layer 2 bridged connectivity between the CEs. There may be multiple EVPN instances in the provider's network.

In an EVPN, MAC learning between PEs occurs not in the data plane (as happens with traditional bridging in VPLS) but in the control plane. Control-plane learning offers greater control over the MAC learning process, such as restricting who learns what, and the ability to apply policies. Furthermore, the control plane chosen for advertising MAC reachability information is multi-protocol (MP) BGP (similar to IP VPNs). In EVPN, PEs advertise the MAC addresses learned from the CEs that are connected to them, along with an MPLS label, to other PEs in the control plane using Multiprotocol BGP (MP-BGP).

In today's VPN solutions customers generally need to configure static attachment points or use a gateway (GW) to capture roving attachment points (e.g. Cellular). Generally speaking customers must run a Layer 3 routing protocol such as Border Gateway Protocol (BGP) and exchange path information to create the reachability between end-points. In the case of cellular it is the GW that does this on behalf of the roving attachment point.

There is no model which has the ability to create an integrated Layer 2-Layer 3 Hybrid VPN network. Currently, there is generally a single default GW that needs to be “programmed” with reachability and made available to the Layer 3 network.

Also, there is currently no network model that facilitates authentication of endpoints wishing to join a VPN network, prior to advertising media access control address (MAC) reachability into a Layer 3 VPN.

### SUMMARY

The problem of having Ethernet only type attachments that dynamically attach and detach from the customer VPN is resolved by an integrated Layer 2-Layer 3 hybrid VPN network.

One general aspect includes a method including: providing a Layer 3 provider edge device that runs in an EVPN domain and a Layer 3 VPN domain and defining an interconnect point between the EVPN domain and the Layer 3 VPN domain; receiving in the Layer 3 provider edge device an IP prefix for a Layer 3 customer edge device disposed in the Layer 3 VPN domain; receiving in the Layer 3 provider edge device, from an EVPN provider edge device disposed in the EVPN domain, a MAC address, an IP address and a next hop address for an EVPN customer edge device disposed in the EVPN domain; leaking at the interconnect point at the Layer 3 provider edge device the IP prefix to the EVPN domain; communicating at the interconnect point the MAC address, the IP address and the next hop address of the EVPN customer edge device to the Layer 3 VPN domain; and transmitting state information to the EVPN provider edge device. Other embodiments of this aspect include corresponding computer systems, apparatus, and computer programs recorded on one or more computer storage devices, each configured to perform the actions of the methods.

Implementations may include one or more of the following features. The method where the interconnect point is defined by retention time alignment. The method where the interconnect point is defined by integrated routing and bridging. The method further including providing state information to the EVPN customer edge device. The method where the state information includes the MAC address of the EVPN customer edge device the IP address of the EVPN customer edge device and the IP prefix of the Layer 3 customer edge device. The method where receiving in the Layer 3 provider edge device an IP prefix for a Layer 3 customer edge device includes receiving the IP prefix through a BGP protocol. The method further including: receiving in the Layer 3 provider edge device, from a second EVPN provider edge device disposed in the EVPN domain, a second MAC address, a second IP address and a second next hop address for a second EVPN customer edge device disposed in the EVPN domain.

Another general aspect includes a system including: a Layer 3 provider edge device that runs in an EVPN domain and a Layer 3 VPN domain defining an interconnect point between the EVPN domain and the Layer 3 VPN domain, where the Layer 3 provider edge device: receives an IP prefix for a Layer 3 customer edge device disposed in the Layer 3 VPN domain; receives a MAC address, an IP address and a next hop address for an EVPN customer edge device disposed in the EVPN domain from a EVPN provider edge device disposed in the EVPN domain; leaks the IP prefix to the EVPN domain; transmits state information to the EVPN customer edge device. Other embodiments of this aspect include corresponding computer systems, apparatus, and computer programs recorded on one or more computer storage devices, each configured to perform the actions of the methods.

Another general aspect includes a non-transitory computer readable medium including computer executable instructions embodied in a computer readable medium and when executed by a processor of a computer performs steps including: receiving an IP prefix for a Layer 3 customer edge device disposed in a Layer 3 VPN domain from a Layer 3 provider edge device, where the Layer 3 provider edge device runs in an EVPN domain and the Layer 3 VPN domain, and defines an interconnect point between the EVPN domain and the Layer 3 VPN domain; receiving in the Layer 3 provider edge device, from an EVPN provider edge device disposed in the EVPN domain, a MAC address, an IP address and a next hop address for an EVPN customer edge device disposed in the EVPN domain; leaking at an interconnect point at the Layer 3 provider edge device the IP prefix to the EVPN domain; communicating at the interconnect point the MAC address, the IP address and the next hop address of the EVPN customer edge device to the Layer 3 VPN domain; and transmitting state information to the EVPN provider edge device. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a schematic of an embodiment of an integrated hybrid network architecture illustrating the data plane learning of Layer 2 devices.

FIG. 2 is a schematic of an embodiment of an integrated hybrid network architecture illustrating the data plane learning between Layer 2 provider edge devices.

FIG. 3 is a schematic of an embodiment of an integrated hybrid network architecture illustrating the transfer of routing information between the Layer 2 devices and a Layer 3 provider edge device.

FIG. 4 is a schematic of an embodiment of an integrated hybrid network architecture illustrating the leaking of routing information at a interconnect point in a Layer 3 provider edge device.

FIG. 5 is a schematic of an embodiment of an integrated hybrid network architecture illustrating the transfer of routing information between the Layer 3 provider edge device and the Layer 2 provider edge devices.

FIG. 6 is a schematic of an embodiment of an integrated hybrid network architecture illustrating the data plane learning of Layer 2 devices.

FIG. 7 is a flowchart illustrating an embodiment of a method for creating an integrated Layer 2-Layer 3 hybrid VPN network.

### DETAILED DESCRIPTION OF ILLUSTRATIVE EMBODIMENTS

### Glossary

BGP. Border Gateway Protocol (BGP) is a standardized exterior gateway protocol designed to exchange routing and reachability information among autonomous systems on the Internet.

Customer edge device. A customer edge (CE) device provides a customer access to the service provider network over a data link to one or more provider edge (PE) devices. The CE device may be an IP router that establishes an adjacency with its directly connected PE routers. A CE device may be a router located on the customer premises that provides an Ethernet interface between the customer's LAN and the provider's core network. CE devices, provider (P) devices and provider edge (PE) devices are components in an MPLS (multiprotocol label switching) architecture. Provider routers are located in the core of the provider or carrier's network. Provider edge routers sit at the edge of the network. CE devices connect to PE devices and PE devices connect to other PE devices over P devices.

EVI. An EVPN instance (EVI) is an EVPN routing and forwarding instance spanning across the provider edges participating in that EVPN. Each EVI is identified by a configured name and is assigned an EVPN instance ID by the device. Each EVI has a unique route distinguisher and one or more route targets. Route targets control the routes to be imported into and exported from the EVPN instance. An EVPN Routing table, containing information about the various routes associated with the EVI, is maintained for each EVI instance.

EVPN. An Ethernet VPN (EVPN) enables you to connect dispersed customer sites using a Layer 2 virtual bridge. As with other types of VPNs, an EVPN consists of CE devices (host, router, or switch) connected to PE devices. The PE devices can include an MPLS edge switch that acts at the edge of the MPLS infrastructure. EVPN uses Border Gateway Protocol (BGP) as the control-plane for MAC address signaling/learning over the core as well as for access topology and VPN endpoint discovery.

Multiprotocol Label Switching (MPLS) Virtual Private Network (VPN) consists of a set of sites that are interconnected by means of an MPLS provider core network. At each customer site, one or more CE devices attach to one or more PE devices.

P device. A P device is a router that functions as a transit router of the core network. The P device is typically connected to one or more PE devices. For example, a customer who has facilities in two separate sites wants to connect these sites over an MPLS VPN provided by a service provider. To do this, the customer would purchase a link from the on-site CE router to the PE router in the service provider's central office and would also do the same thing in each of the two sites. The PE routers would connect over service provider's backbone routers (P routers) to enable the two CE routers in the two sites to communicate over the MPLS network.

PE device. A PE device may be a router between one network service provider's area and areas administered by other network providers.

Routing Protocol. A routing protocol specifies how routers communicate with each other, disseminating information that enables them to select routes between any two nodes on a computer network. Routing algorithms determine the specific choice of route. Each router has a priori knowledge only of networks attached to it directly. A routing protocol shares this information first among immediate neighbors, and then throughout the network. This way, routers gain knowledge of the topology of the network.

VPN. A VPN is a virtualized extension of a private network across a public network, such as the Internet. It enables users to send and receive data across shared or public networks as if their computing devices were directly connected to the private network. Applications running across the VPN may therefore benefit from the functionality, security, and management of the private network.

VRF. In IP-based computer networks, virtual routing and forwarding (VRF) is a technology that allows multiple instances of a routing table to co-exist within the same router at the same time. Because the routing instances are independent, the same or overlapping IP addresses can be used without conflicting with each other. VRF may be implemented in a network device by distinct routing tables. VRFs operate without knowledge of one another unless they are imported or exported into one another using Inter-VRF Route Leaking. Inter-VRF route leaking allows leaking of route prefixes from one VRF instance to another VRF instance on the same physical router, which eliminates the need for external routing.

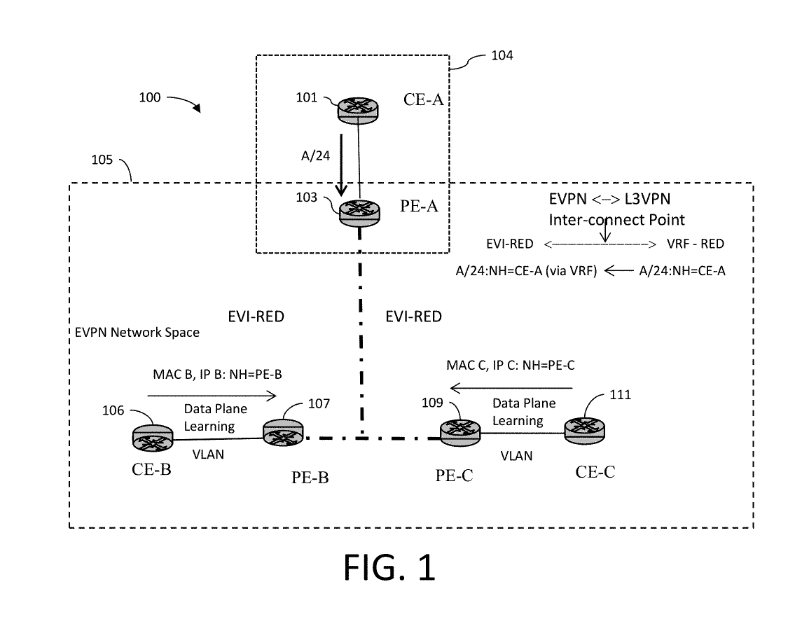

Illustrated in FIG. 1 is an embodiment of an integrated hybrid network architecture 100 which, as an example, may be operated by a customer RED. The integrated hybrid network architecture 100 may include a customer edge device CE-A 101 and a provider edge device PE-A 103 which define a Layer 3 VPN 104. Although a single CE and a single PE are illustrated, Layer 3 VPN 104 may include a plurality of CEs and PEs. CE-A 101 may be a router, a label switch router (LSR) or host that has no VPN-specific functionality and is attached by an access connection to the PE-A 103. PE-A 103 may be connected to CE-A 101 using Ethernet and may also run a BGP protocol between CE-A 101 and PE-A 103. PE-A 103 is a provider edge router that provides EVPN and Layer 3 VPN services. Once CE-A 101 connects and constructs a BGP session between CE-A 101 and PE-A 103, CE-A 101 advertises the prefix A/24 to PE-A 103. This occurs in a Layer 3 VPN (VRF RED). The A/24 prefix may be made available to the EVPN domain 105 that is comprised of CE-B 106, PE-B 107, PE-C 109, CE-C 111 and PE-A 103. PE-A 103 operates in both the Layer 3 VPN (Layer 3 VPN domain 104) and in a Layer 2 EVPN (EVPN domain 105). The A/24 prefix is leaked into the EVPN domain (EVI RED). EVI RED is the Layer 2 (EVPN) context which may hold state information such as MAC state, associated IP information and some rudimentary IP prefix information such as A/24. Leaking means moving or advertising the state between the two contexts. A/24 is advertised as a pure IP prefix to PE-B 107 and PE-C 109. A/24 becomes available in the EVPN context RED, so that if one wants to send traffic to A/24 then that A/24 routing information is available to them. So traffic from CE-B to PE-B destined for IP address A/24 will be routed to the destination.

Also illustrated in FIG. 1 is the data plane learning between CE-B 106 and PE-B 107 and the data plane learning between CE-C 111 and PE-B 109. CE-B 106 advertises the MAC address for CE-B 106 (MAC B), the IP address for CE-B 106 (IP B), and the next hop address (NH=PE-B). Similarly, CE-C 111 advertises the MAC address for CE-C 111 (MAC C), the IP address for CE-C 111 (IP C), and the next hop address (NH=PE-C). There is no protocol running, only Ethernet.

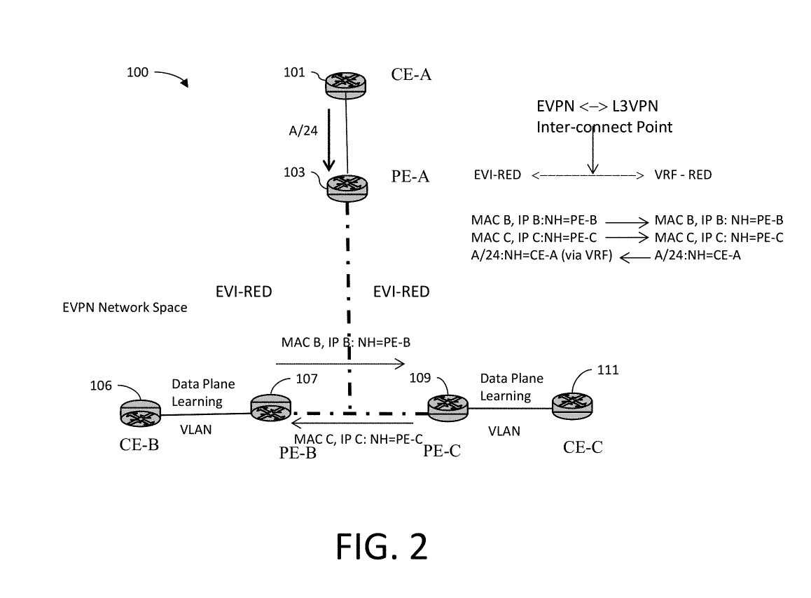

As shown in FIG. 2. PE-B 107 advertises the routing information for CE-B 106 (MAC B, IP B, NH=PE-B) to PE-C 109 and PE-C 109 advertises the routing information for CE-C (MAC C, IP C, NH=PE-C) to PE-B 107.

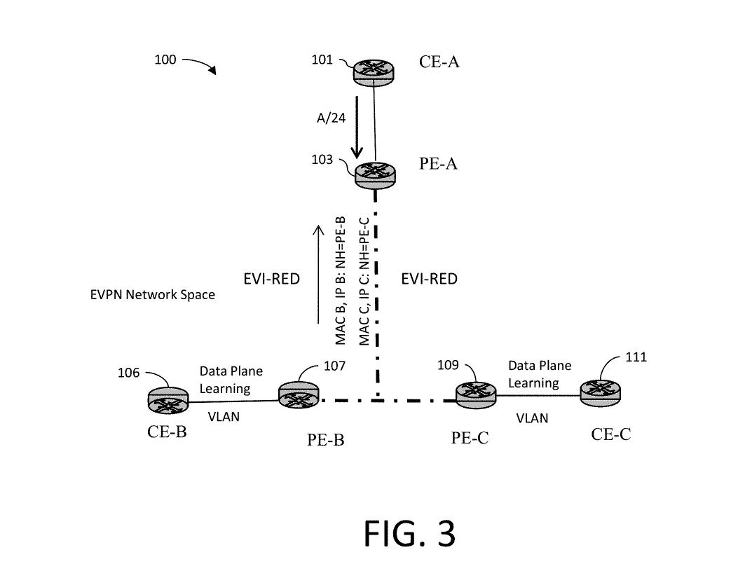

FIG. 3 illustrates that the routing information for CE-B 106 and CE-B 107 is advertised to PE-A 103.

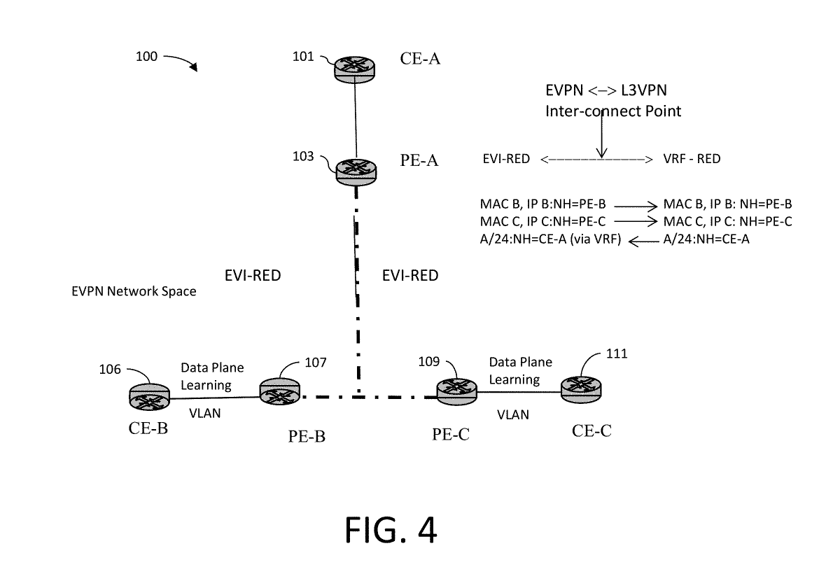

FIG. 4 illustrates how PE-A 103 serves as the interconnect point between the EVPN domain and the VPN domain. The interconnect point may be defined via retention time (RT) alignment or an artifice such as integrated routing and bridging (IRB). The CE-B 106 and CE-C 111 routing information is transferred to the Layer 3 VPN domain (VRF-RED) and the CE-A A/24 prefix is leaked and made available to the EVPN domain.

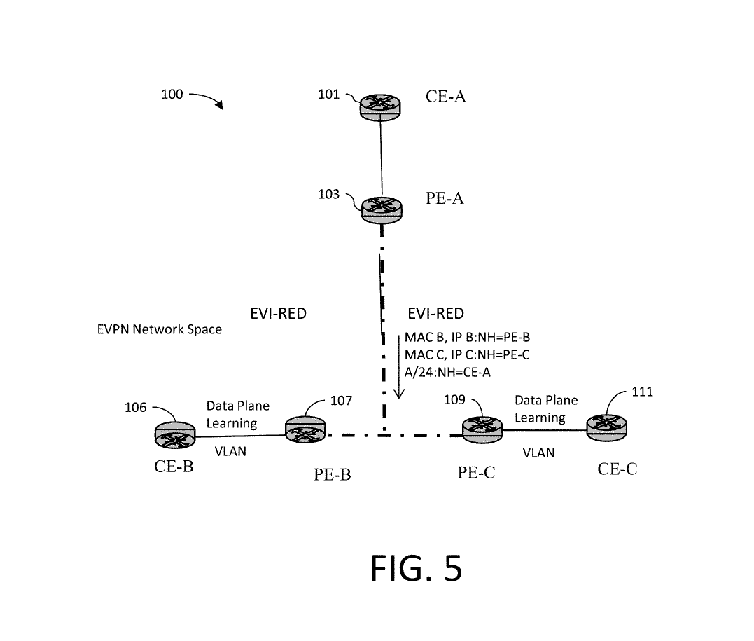

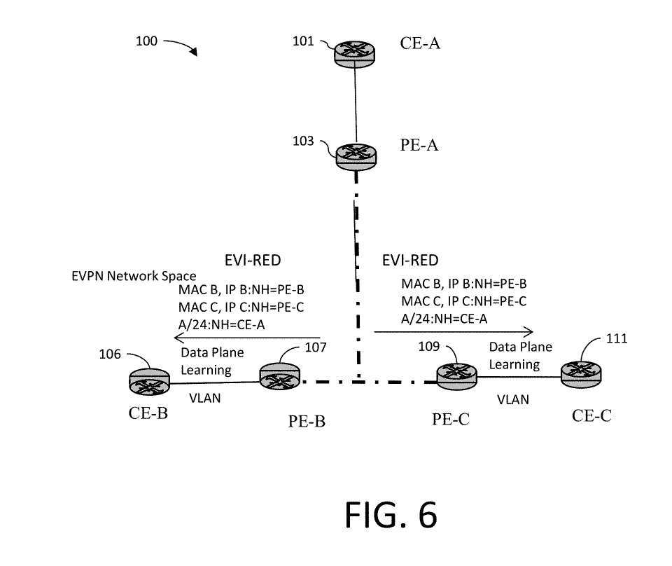

As shown in FIG. 5 the state information for CE-A 101, CE-B 106 and CE-C 111 is then published to PE-B 107, and PE-C 109, and the as illustrated in FIG. 6 the state information is published to CE-B 106 and CE-C 111.

The integrated hybrid network architecture 100 extends a traditional Layer 3 VPN by allowing Layer 2 endpoints to dynamically attach to it. The integrated hybrid network architecture 100 utilizes both BGP/MPLS VPN (described in Request for Comments (RFC) 4364 published by the Internet Engineering Task Force) and BGP/MPLS EVPN (RFC 7432). Using Layer 3 VPN technology (described in RFC 4064) and Layer 2 EVPN technology (described in RFC 7413) in a complimentary manner one can dynamically exchange routing state between the two domains to realize an internet of things (IoT) network. The foregoing RFCs are hereby incorporated by reference.

The integrated hybrid network architecture 100 provides customer connectivity. A given set of customer sites will connect directly to the EVPN PEs and only perform data plane learning between EVPN PEs and the customer site. There is no protocol running, only Ethernet. A given set of “roving” customer sites may attach to either Layer 3 gateway (GW) or to a Layer 2 GWs where they will be attached to the customer's VPN. A given set of customer sites may connect to Layer 3 PEs and run a routing protocol, i.e. BGP.

The integrated hybrid network architecture 100 provides inter-network functionality. A set of PEs will run both EVPN and Layer 3 VPN software and act as the GWs between the two technologies. Dynamic exchange of routing state will be done between an EVPN and Layer 3 VPN context.

The integrated hybrid network architecture 100 provides for authentication. Authentication may be done dynamically when a MAC is learned via a customer connection. Prior to allowing that MAC to participate in the customer VPN the MAC may be sent to a radius or other server for authentication.

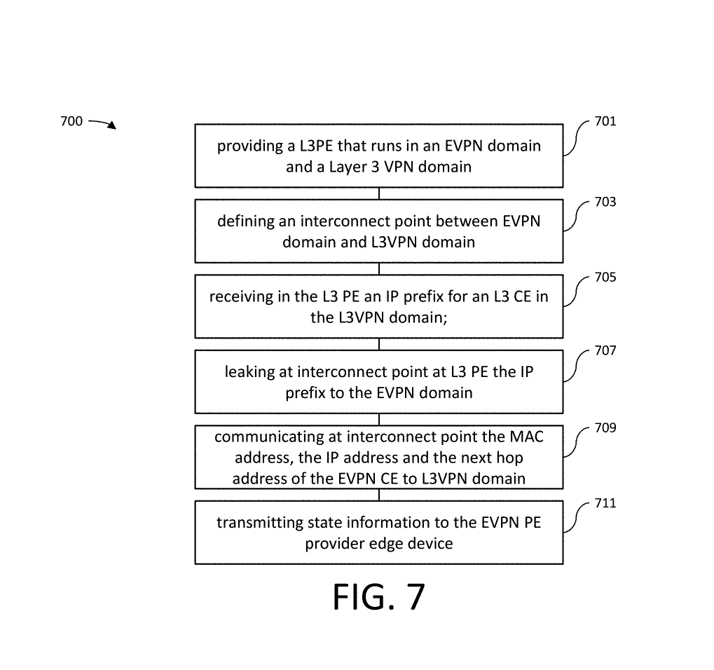

FIG. 7 is a flowchart illustrating an embodiment of a method 700 for creating an integrated Layer 2-Layer 3 hybrid VPN network.

In step 701 the method 700 provides a Layer 3 PE (e.g. PE-A 105) that runs in an EVPN domain and a Layer 3 VPN domain.

In step 703 the method 700 defines an interconnect point between the EVPN domain and the Layer 3 VPN domain. The interconnect point may be defined by retention time alignment or by integrated routing and bridging.

In step 705 the method 700 receives in the Layer 3 PE an IP prefix for a Layer 3 CE (e.g. CE-B 106) disposed in the Layer 3 VPN domain. The IP prefix is received through a BGP protocol. The Layer 3 PE may also receive a second MAC address, a second IP address and a second next hop address for a second EVPN CE disposed in the EVPN domain

In step 707 the method 700 leaks at the interconnect point at the Layer 3 PE the IP prefix to the EVPN domain.

In step 709 the method 700 communicates at the interconnect point the MAC address, the IP address and the next hop address of the EVPN CE to the Layer 3 VPN domain.

In step 711 the method 700 transmits state information to the EVPN PE. Thereafter the EVPN PE may provide state information to the EVPN CE. The state information comprises the MAC address of the EVPN CE, the IP address of the EVPN CE and the IP prefix of the Layer 3 CE.

The methods described in the examples may be embodied directly in hardware, in a software module executed by a processor, or in a combination of the two. A software module may reside in any form of memory or storage medium such as RAM memory, flash memory, ROM memory, EPROM memory, EEPROM memory, registers, hard disk, a removable disk, a CD-ROM. The memory or storage medium may be coupled to the processor such that the processor can read information from, and write information to, the memory or storage medium. Alternatively, the storage medium may be integral to the processor. The processor and the storage medium may reside in an ASIC. In some aspects, the steps and/or actions of a method may reside as one or any combination or set of codes and/or instructions on a machine readable medium and/or computer readable medium, which may be incorporated into a computer program product.

In any of the exemplary embodiments, the described functions may be implemented in hardware, software, firmware, or any combination thereof. Functions implemented in software may be stored on or transmitted over as instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed:

1. A method comprising:
providing a Layer 3 provider edge device that runs in an EVPN domain and a Layer 3 VPN domain;
defining an interconnect point between the EVPN domain and the Layer 3 VPN domain;
receiving in the Layer 3 provider edge device an IP prefix for a Layer 3 customer edge device disposed in the Layer 3 VPN domain;
leaking at the interconnect point at the Layer 3 provider edge device the IP prefix to the EVPN domain;
communicating at the interconnect point the MAC address, the IP address and the next hop address of the EVPN customer edge device to the Layer 3 VPN domain; and
transmitting state information to the EVPN provider edge device.

2. The method of claim 1 wherein the interconnect point is defined by retention time alignment.

3. The method of claim 1 wherein the interconnect point is defined by integrated routing and bridging.

4. The method of claim 1 further comprising providing state information to the EVPN customer edge device.

5. The method of claim 1 wherein the state information comprises the MAC address of the EVPN customer edge device, the IP address of the EVPN customer edge device and the IP prefix of the Layer 3 customer edge device.

6. The method of claim 1 wherein receiving in the Layer 3 provider edge device an IP prefix for a Layer 3 customer edge device comprises receiving the IP prefix through a BGP protocol.

7. The method of claim 1 further comprising:
receiving in the Layer 3 provider edge device, from a second EVPN provider edge device disposed in the EVPN domain, a second MAC address, a second IP address and a second next hop address for a second EVPN customer edge device disposed in the EVPN domain.

8. A system comprising:
a Layer 3 provider edge device that runs in an EVPN domain and a Layer 3 VPN domain defining an interconnect point between the EVPN domain and the Layer 3 VPN domain, wherein the Layer 3 provider edge device:
receives an IP prefix for a Layer 3 customer edge device disposed in the Layer 3 VPN domain;
receives a MAC address, an IP address and a next hop address for an EVPN customer edge device disposed in the EVPN domain from an EVPN provider edge device disposed in the EVPN domain;
leaks the IP prefix to the EVPN domain; and
transmits state information to the EVPN customer edge device.

9. The system of claim 8 wherein the interconnect point is defined by retention time alignment.

10. The system of claim 8 wherein the interconnect point is defined by integrated routing and bridging.

11. The system of claim 8 further comprising providing state information to the EVPN customer edge device.

12. The system of claim 8 wherein the state information comprises the MAC address of the EVPN customer edge device, the IP address of the EVPN customer edge device and the IP prefix of the Layer 3 customer edge device.

13. The system of claim 8 wherein receiving in the Layer 3 provider edge device an IP prefix for a Layer 3 customer edge device comprises receiving the IP prefix through a BGP protocol.

14. The system of claim 8 wherein the Layer 3 provider edge device:
receives in the Layer 3 provider edge device, from a second EVPN provider edge device disposed in the EVPN domain, a second MAC address, a second IP address and a second next hop address for a second EVPN customer edge device disposed in the EVPN domain.

15. A non-transitory computer readable medium comprising computer executable instructions embodied in a computer readable medium and when executed by a processor of a computer performs steps comprising:
receiving an IP prefix for a Layer 3 customer edge device disposed in a Layer 3 VPN domain from a Layer 3 provider edge device, wherein the Layer 3 provider edge device runs in an EVPN domain and the Layer 3 VPN domain, and defines an interconnect point between the EVPN domain and the Layer 3 VPN domain;
receiving in the Layer 3 provider edge device, from an EVPN provider edge device disposed in the EVPN domain, a MAC address, an IP address and a next hop address for an EVPN customer edge device disposed in the EVPN domain;
leaking at an interconnect point at the Layer 3 provider edge device the IP prefix to the EVPN domain;
communicating at the interconnect point the MAC address, the IP address and the next hop address of the EVPN customer edge device to the Layer 3 VPN domain; and
transmitting state information to the EVPN provider edge device.

16. The non-transitory computer readable medium of claim 15 wherein the interconnect point is defined by retention time alignment.

17. The non-transitory computer readable medium of claim 15 wherein the interconnect point is defined by integrated routing and bridging.

18. The non-transitory computer readable medium of claim 15 further comprising providing state information to the EVPN customer edge device.

19. The non-transitory computer readable medium of claim 15 wherein the state information comprises the MAC address of the EVPN customer edge device, the IP address of the EVPN customer edge device and the IP prefix of the Layer 3 customer edge device.

20. The non-transitory computer readable medium of claim 15 wherein receiving in the Layer 3 provider edge device an IP prefix for a Layer 3 customer edge device comprises receiving the IP prefix through a BGP protocol.
